(19) United States
(12) Patent Application Publication
(10) Pub. No.: US 2018/0234833 A1
(43) Pub. Date: Aug. 16, 2018

(54) MOBILE TERMINAL AND METHOD FOR SHARING SIM CARD

(71) Applicant: MediaTek Singapore Pte. Ltd., Singapore (SG)

(72) Inventors: MI TANG, Beijing City (CN); YAJUN LI, Beijing City (CN); Ming-Pei Hsu, New Taipei City (TW); ZHONGE WU, Beijing City (CN); Yuanyuan Wang, Beijing City (CN)

(21) Appl. No.: 15/891,387

(22) Filed: Feb. 8, 2018

(30) Foreign Application Priority Data
Feb. 10, 2017 (CN) 201710072936.9

(51) Int. Cl. H04W 8/18; H04W 8/20; H04W 88/06

(52) U.S. Cl. CPC H04W 8/183; G06K 19/07739; H04W 88/06; H04W 8/205

(57) ABSTRACT

The present invention provides methods for sharing a SIM card and mobile terminals. The method comprises: utilizing a first mobile terminal to receive a SIM card access request signal from at least a second mobile terminal which does not have the SIM card, wherein the first mobile terminal has the SIM card and operates as a server having no fixed IP; transmitting a security authentication information request signal to the second mobile terminal according to the SIM card access request signal; and determining whether to transmit a SIM card Elementary Files data to the second mobile terminal according to the security authentication information, wherein the SIM card Elementary Files data is utilized by the second mobile terminal to use communication function of the SIM card. The present invention allows the mobile terminals to share a SIM card.

### BACKGROUND

Please refer to FIG. 1. FIG. 1 is a simplified block diagram of a conventional system 10 where a plurality of mobile terminals uses their own Subscriber Identity Circuit (SIM) cards. As shown in FIG. 1, the system 10 comprises a smart phone 20 and a smart watch 30. The smart phone 20 has a SIM card 22 and the smart watch 30 has a SIM card 32. In general, the user has to purchase communication packages for the SIM card 22 of the smart phone 20 and the SIM card 32 of the smart watch 30, respectively. The SIM card 22 and the SIM card 32 are not capable of sharing the communication packages, and thus it usually result in a waste of money. In addition, when the user forgets to bring the smart phone but is waiting for important phone calls, the user will expect he/she can borrow a phone being capable of using the SIM card in his/her own smart phone to answer/dial phone calls. Or, sometimes it is not convenient to take the smart phone, the user will expect to have a wearable smart device capable of using the SIM card in his/her own smart phone to answer/dial phone calls.

One conventional solution is utilizing telecom operator 40 by mapping the number of the SIM card 22 to the number of the SIM card 32 and setting a main display number. When the user makes phone calls by either one of the above SIM cards, a same identity will be shown. However, this solution requires operation of the telecom operator, and it still requires a plurality of SIM cards for the corresponding mobile terminals. Another conventional solution is that the telecom operator 40 sends permit of accessing the SIM card 22 in the smartphone 20 to the smart watch 30 in the form of a virtual SIM card, and the SIM card 22 in the smartphone 20 is not capable of communication. However, this solution still requires operation of the telecom operator and needs to additionally synchronize the communication records of the smartphone 20 with the smart watch 30.

### SUMMARY

According to a first aspect of the present invention, an exemplary method for sharing a Subscriber Identity Circuit (SIM) card is disclosed. The exemplary method comprises: utilizing a first mobile terminal to receive a SIM card access request signal from at least a second mobile terminal which does not have the SIM card, wherein the first mobile terminal has the SIM card and operates as a server having no fixed IP; transmitting a security authentication information request signal to the second mobile terminal according to the SIM card access request signal; and determining whether to transmit a SIM card Elementary Files data to the second mobile terminal according to the security authentication information, wherein the SIM card Elementary Files data is utilized by the second mobile terminal to use a communication function of the SIM card. In an embodiment, the method further comprises determining a security level of the second mobile terminal according to the security authentication information; and transmitting a communication information corresponding to the security level to the second mobile terminal according to the security level. In another embodiment, the communication information comprises a communication record information, a contact list information, a short message information, and/or a permission control information.

According to a second aspect of the present invention, an exemplary method for sharing a SIM card is disclosed. The exemplary method comprises: utilizing a second mobile terminal which does not have the SIM card to transmit a SIM card access request signal to a first mobile terminal, wherein the first mobile terminal has the SIM card and operates as a server having no fixed IP; receiving a security authentication information request signal from the first mobile terminal; and utilizing the security authentication information request signal to transmit a security authentication information to the first mobile terminal; receiving a SIM card Elementary Files data from the first mobile terminal; and using a communication function of the SIM card according to the SIM card Elementary Files data. In an embodiment, when the SIM card receives a phone signal, the second mobile terminal uses the SIM card to receive the phone signal. In another embodiment, it is determined that whether to synchronize a calling information corresponding to the phone signal to the first mobile terminal.

According to a third aspect of the present invention, an exemplary mobile terminal is disclosed. The exemplary mobile terminal comprises: a transceiver, for receiving a SIM card access request signal from at least a second mobile terminal which does not have the SIM card, wherein the mobile terminal has the SIM card and operates as a server having no fixed IP; and a control circuit, for transmitting a security authentication information request signal to the second mobile terminal according to the SIM card access request signal; and determining whether to transmit a SIM card Elementary Files data to the second mobile terminal according to the security authentication information, wherein the SIM card Elementary Files data is utilized by the second mobile terminal to use a communication function of the SIM card.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of a conventional system where a plurality of mobile terminals uses their own Subscriber Identity Module (SIM) card.

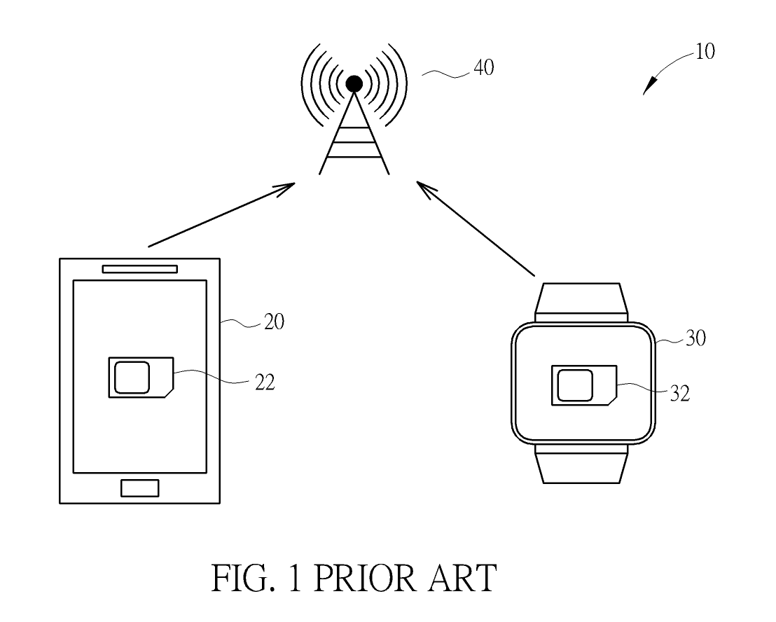

FIG. 2 is a simplified block diagram of a system for a plurality of mobile devices share one SIM card according to an embodiment of the present invention.

FIG. 3 is a simplified diagram of a signal flowchart between the plurality of mobile devices.

FIG. 4 is a simplified diagram of a signal flow between the plurality of mobile terminals according to an embodiment of the present invention, showing how the second mobile terminal uses the communication function of the SIM card according to the SIM card EF data EF.

FIG. 5 is a block diagram of a first mobile terminal and a second mobile terminal according to an embodiment of the present invention.

FIG. 6 is a flowchart showing a method for sharing a SIM card in accordance with an embodiment of the present invention.

### DETAILED DESCRIPTION

Certain terms are used throughout the description and following claims to refer to particular components. As one skilled in the art will appreciate, manufacturers can refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection can be via a direct electrical connection, or via an indirect electrical connection via other devices and connections.

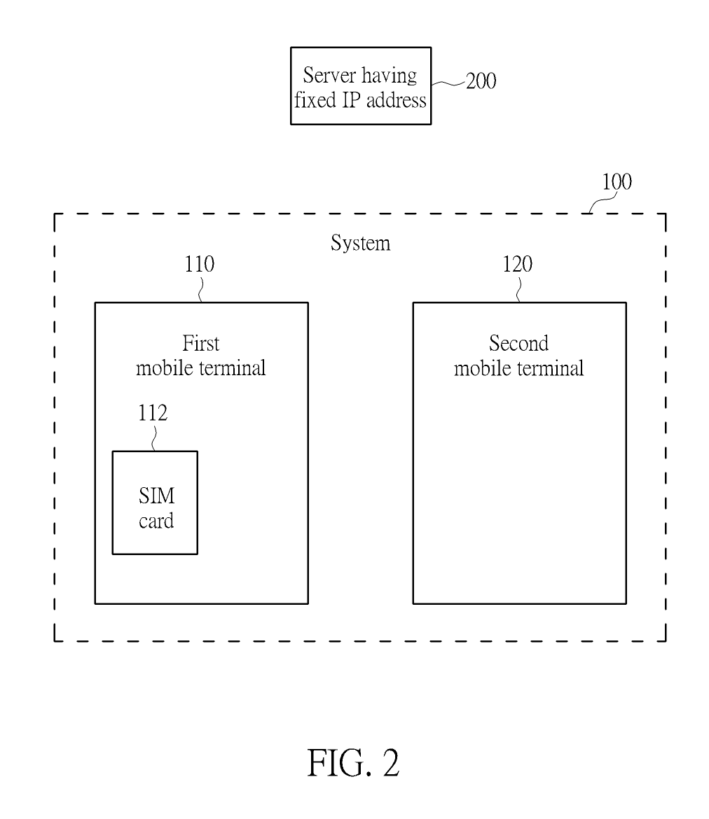

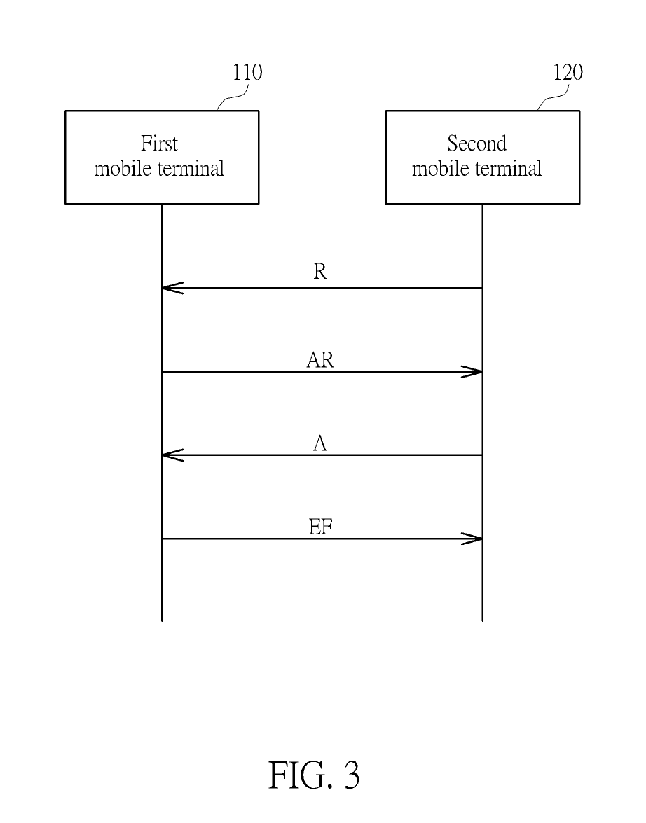

Please refer to FIG. 2 and FIG. 3. FIG. 2 is a simplified block diagram of a system 100 for a plurality of mobile devices share one SIM card according to an embodiment of the present invention. FIG. 3 is a simplified diagram of a signal flowchart between the plurality of mobile devices. As shown in FIG. 2, the system 100 comprises a first mobile terminal 110 and a second mobile terminal 120. The first mobile terminal 110 and the second mobile terminal 120 can be mobile devices such as smartphones, smart watches, smart wristbands, or tablet computers. The first mobile terminal 110 has a SIM card 112 and operates as a server having no fixed IP address. According to different design requirements, the first mobile terminal 110 may “have” the SIM card 112 in different ways. For example, the physical SIM card 112 can be inserted into the first mobile terminal 110, or the first mobile terminal 110 can be coupled to the SIM card 112, or the first mobile terminal 110 can be bound with a virtual SIM card. This is only for an illustrative purpose and is not meant to be a limitation of the present invention.

As shown in FIG. 3, the second mobile terminal 120 can transmit a SIM card access request signal R to the first mobile terminal 110. The first mobile terminal 110 can transmit a security authentication information request signal AR to the second mobile terminal 120 according to the SIM card access request signal R after receiving the SIM card access request signal R. The second mobile terminal 120 can transmit a security authentication information A to the first mobile terminal 110 according to the security authentication information request signal AR after receiving the security authentication information request signal AR. The first mobile terminal 110 can determine whether to transmit a SIM card Elementary Files (EF) data EF to the second mobile terminal 120 according to the security authentication information A after receiving the security authentication information A. For example, the first mobile terminal 110 can determine whether the received security authentication information A pass the security authentication. If the received security authentication information A pass the security authentication, then the first mobile terminal 110 transmits (for example, transmits by a current secure method) the SIM card Elementary Files (EF) data EF to the second mobile terminal 120. If the received security authentication information A fails to pass the security authentication, then the first mobile terminal 110 does not perform the follow-up data transmitting operation.

After the second mobile terminal 120 receives the SIM card EF data EF, the second mobile terminal 120 can use a communication function of the SIM card 112 according to the SIM card EF data EF. According to some embodiments, using the communication function of the SIM card 112 can require cooperation of the first mobile terminal 110, such as transmitting the operator authentication information by the first mobile terminal 110. The communication function can be functions provided by the operator for the SIM card 112, such as answering/making phone calls, receiving/sending messages, or connecting to the internet. The first mobile terminal 110 also can determine a security level of the second mobile terminal 120 according to the security authentication information A, and determine which permission level the second mobile terminal 120 can use to use the communication function of the SIM card 112 according to the security level of the second mobile terminal 120. For example, the security authentication information A can be information for security authentication such as passwords, fingerprints, or clicking on specified elements on interface. The security levels from low to high can be: clicking on specified elements on interface of the second mobile terminal 120, inputting a password preset by the first mobile terminal 110 when the second mobile terminal 120 transmits the request, inputting a fingerprint preset by the first mobile terminal 110 when the second mobile terminal 120 transmits the request, and the second mobile terminal 120 being pre-authenticated by the first mobile terminal 110. The first mobile terminal 110 can perform security and permission control for the second mobile terminal 120 according to the security level of the second mobile terminal 120. For example, the first mobile terminal 110 can transmit communication information (e.g., permission control information) corresponding to the security level to the second mobile terminal 120 according to the security level. In this way, the first mobile terminal 110 can control the information type transmitted with the SIM card 112, such as sending one-day calling record, or defining time limit (e.g., time length) of using the SIM card 112 by the second mobile terminal 120, or not allowing the second mobile terminal 120 to store any communication records. In addition, the number of mobile terminals can be changed according to different design requirements. If the first mobile terminal 110 is a dual card mobile phone or a multi-card mobile phone, the first mobile terminal 110 may provide a SIM card or a plurality of SIM cards for other mobile terminals, and the rest SIM cards that are not provided to other mobile terminals can still perform normal communication operations on the first mobile terminal 110. In addition, in the present invention, all of the above-mentioned functions of the first mobile terminal 110 and the second mobile terminal 120 can be realized by one or a combination of software, hardware, and firmware.

The first mobile terminal 110 can decide whether to enable the above-described SIM server function (i.e., the virtual SIM server function), and set a password when the SIM server function is determined to be enabled. After the first mobile terminal 110 receives the SIM card access request signal R, the first mobile terminal 110 can transmit a password request signal and a first public key to the second mobile terminal 120 according to the SIM card access request signal R. After the user of the second mobile terminal 120 inputs the password, the second mobile terminal 120 transmits the password encrypted by the first public key to the first mobile terminal 110. Next, after the first mobile terminal 110 decrypts the password encrypted by the first public key with a first private key and verifies that the password is correct, the first mobile terminal 110 can communicate with the second mobile terminal 120 to request a second public key. Subsequently, the second mobile terminal 120 can transmit the second public key to the first mobile terminal 110. Next, the first mobile terminal 110 can provide the permission of the communication function of the SIM card 112 to the second mobile terminal 120. The second mobile terminal 120 can communicate with the first mobile terminal 110 to request the SIM card EF data EF. The first mobile terminal 110 can transmit the SIM card EF data EF encrypted by the second public key to the second mobile terminal 120. The second mobile terminal 120 can store the SIM card EF data EF encrypted by the second public key in a secure storage area and use a second private key to decrypt the SIM card EF data EF encrypted by the second public key when there is a requirement. Of course, the present invention is not limited thereto. Other security authentication methods can be utilized between the first mobile terminal 110 and the second mobile terminal 120 according to different design requirements.

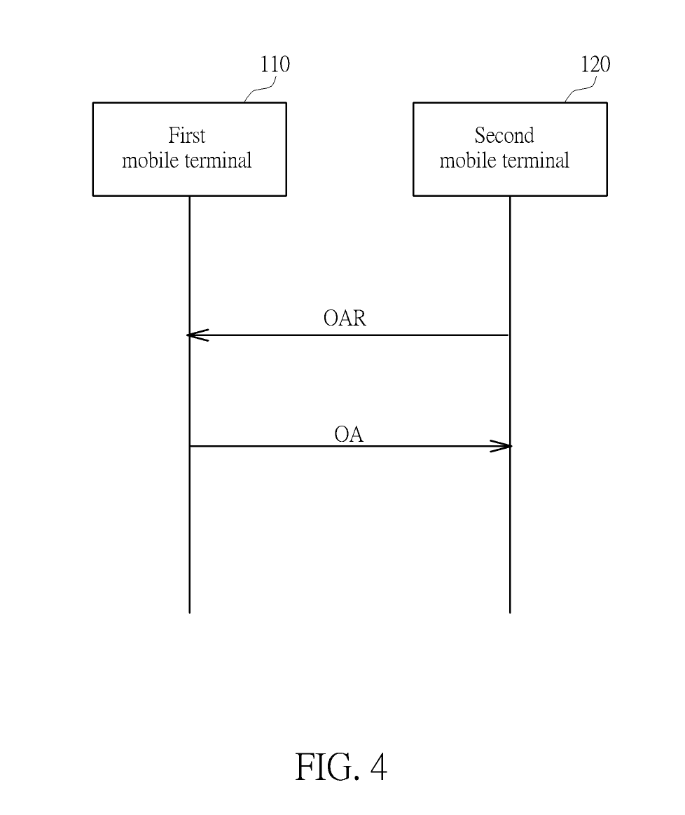

FIG. 4 is a simplified diagram of a signal flow between a plurality of mobile terminals according to an embodiment of the present invention, showing how the second mobile terminal 120 uses the communication function of the SIM card 112 according to the SIM card EF data EF. As shown in FIG. 4, the second mobile terminal 120 can transmit an operator authentication permission information request signal OAR to the first mobile terminal 110 according to the SIM card EF data EF to request an operator authentication permission information OA. The first mobile terminal 110 can transmit the operator authentication permission OA to the second mobile terminal 120 according to the authentication authorization information request signal OAR. In this way, the second mobile terminal 120 can use the communication function of the SIM card 112 according to the SIM card EF data EF and the operator authentication authorization information OA.

In a first example, the first mobile terminal 110 and the second mobile terminal 120 can perform the above-described signal transmission operation via a server 200 having a fixed IP address. The server 200 can be a third-party server (operator server). In other embodiments, the first mobile terminal 110 and the second mobile terminal 120 can also perform the above-described signal transmission operations via the gateway. For the sake of simplicity, it will be understood by those skilled in the art that in the present invention that the gateway is also included if “the server with the fixed IP address” is adopted. For example, the second mobile terminal 120 can transmit the SIM card access request signal R to the first mobile terminal 110 via the server 200 having the fixed IP address. The first mobile terminal 110 can transmit the security authentication information request signal AR to the second mobile terminal 120 via the server 200 having the fixed IP address according to the SIM card access request signal R. The second mobile terminal 120 can transmit the security authentication information A to the first mobile terminal 110 via the server 200 having the fixed IP address according to the security authentication information request signal AR. The first mobile terminal 110 can transmit the SIM card EF data EF of the SIM card 112 to the second mobile terminal 120 via the server 200 having the fixed IP address according to the security authentication information A. The first mobile terminal 110 can transmit the operator authentication authorization information OA to the second mobile terminal 120 via the server 200 having the fixed IP address according to the authentication authorization information request signal OAR. The second mobile terminal 120 can transmit the operator authentication authorization information request signal OAR to the first mobile terminal 110 via the server 200 having the fixed IP address according to the SIM card EF data EF to request the operator authentication authorization information OA.

In a second example, the first mobile terminal 110 and the second mobile terminal 120 can transmit signals directly to each other after finding each other via the server 200 having the fixed IP address, other than transmit the signals via the server 200. For example, after the second mobile terminal 120 transmits the SIM card access request signal R to the first mobile terminal 110 via the server 200 having the fixed IP address, the first mobile terminal 110 can establish a connection with the second mobile terminal 120 via the server 200 having the fixed IP address. After the connection is established, the subsequent security authentication information request signal AR, the security authentication information A, the SIM card EF information EF, the operator authentication authorization information request OAR, and the operator authentication authorization information OA, can all be directly transmitted between the first mobile terminal 110 and the second mobile terminal 120.

In a third example, the second mobile terminal 120 also can transmit a signal to the first mobile terminal 110 via a short message service (SMS) to establish a connection with the first mobile terminal 110. After the connection is established, the first mobile terminal 110 and the second mobile terminal 120 can directly transmit signals to each other without via the server 200 with the fixed IP address. For example, the first mobile terminal 110 can establish a connection with the second mobile terminal 120 after the second mobile terminal 120 transmits the SIM card access request signal R to the first mobile terminal 110 via the SMS. After the connection is established, the subsequent security authentication information request signal AR, the security authentication information A, the SIM card basic archival information EF, the operator authentication authorization information request OAR, and the operator authentication authorization information OA, can all be directly transmitted between the terminal 110 and the second mobile terminal 120.

According to an embodiment of the present invention, the first mobile terminal 110 can also transmit the communication information corresponding to the security level to the second mobile terminal 120 according to the security level of the second mobile terminal 120. According to various embodiments, the communication information can be communication record information, contact list information, SMS, and/or permission control information. Of course, the present invention is not limited thereto, and the communication information can include any information for supporting the communication function. The permission control information can correspond to the communication time limits, the times restrictions of communication, and the transmitting information range restrictions. After the second mobile terminal 120 passes the security authentication and is capable of using the communication function of the SIM card 112 and connecting to the internet, when the SIM card 112 in the first mobile terminal 110 receives a telephone signal, the mobile terminal 120 can use the SIM card 112 to receive the telephone signal. After the second mobile terminal 120 uses the SIM card 112 to receive the telephone signal, the second mobile terminal 120 can decide whether to synchronize the incoming call information corresponding to the telephone signal to the first mobile terminal 110 according to the communication information (e.g., the permission control information) from the first mobile terminal 110. In addition, after the second mobile terminal 120 receives the telephone signal using the SIM card 112, the second mobile terminal 120 also can decide whether to store the incoming call information corresponding to the telephone signal in the second mobile terminal 120 according to the communication information (e.g., the permission control information) from the first mobile terminal 110. In addition, after the second mobile terminal 120 receives the telephone signal using the SIM card 112, the second mobile terminal 120 also can decide whether to send the communication record corresponding to the telephone signal back to the first mobile terminal 110. This is only for an illustrative purpose and is not meant to be a limitation of the present invention. Depending on the design requirements, those skilled in the art can add or omit certain steps. For example, the step of determining whether to synchronize the incoming call information and the step of determining whether to store the communication record can be omitted.

According to another embodiment of the present invention, after the second mobile terminal 120 passes the security authentication and is capable of using the communication function of the SIM card 112 and connecting to the internet, when the second mobile terminal 120 transmits a telephone signal (i.e., Dialing the telephone), the first mobile terminal 110 or the second mobile terminal 120 can firstly determine whether to allow the second mobile terminal 120 to transmit the telephone signal using the SIM card 112 according to the security level of the second mobile terminal 120. When the second mobile terminal 120 is allowed to transmit the telephone signal using the SIM card 112, the second mobile terminal 120 can successfully make a phone call. In addition, after the second mobile terminal 120 transmits the telephone signal using the SIM card 112, the second mobile terminal 120 can decide whether to synchronize the calling information corresponding to the telephone signal to the first mobile terminal 110 as the server. In addition, after the second mobile terminal 120 transmits the telephone signal using the SIM card 112, the second mobile terminal 120 can decide whether to store the calling information corresponding to the telephone signal in the second mobile terminal 120 according to the communication information (e.g., the permission control information) from the first mobile terminal 110. In addition, after the second mobile terminal 120 transmits the telephone signal using the SIM card 112, the second mobile terminal 120 also can decide whether to send the communication record corresponding to the telephone signal back to the first mobile terminal 110 as the server. This is only for an illustrative purpose and is not meant to be a limitation of the present invention. Depending on the design requirements, those skilled in the art can add or omit certain steps. For example, the step of determining whether to synchronize the calling information and the step of determining whether to store the communication record can be omitted.

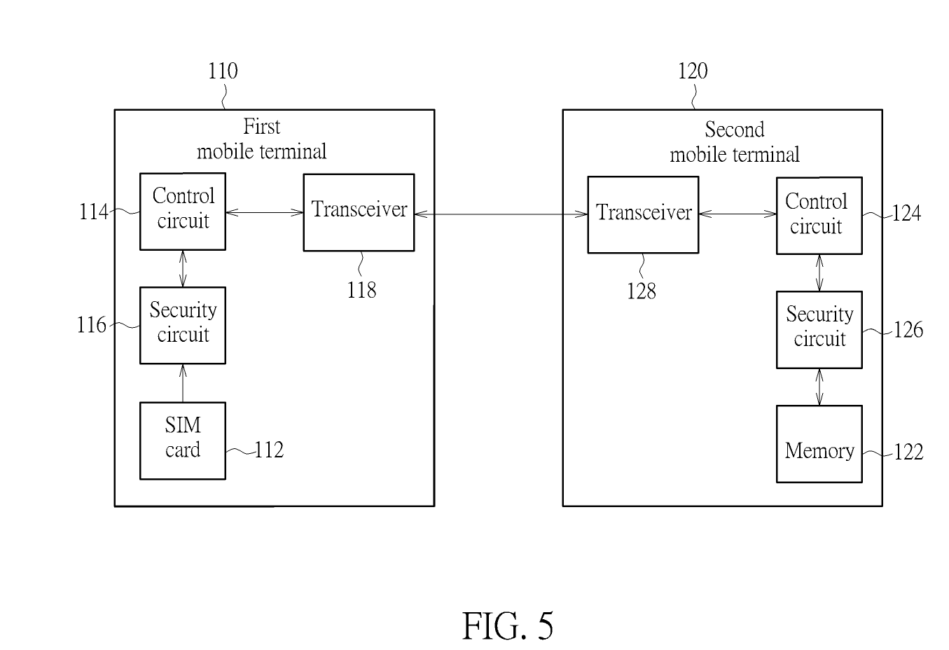

FIG. 5 is a block diagram of a first mobile terminal 110 and a second mobile terminal 120 according to an embodiment of the present invention. As shown in FIG. 5, the first mobile terminal 110 comprises a control circuit 114, a security circuit 116, and a transceiver 118. The first mobile terminal 110 further has a SIM card 112. Although in the present embodiment the SIM card 112 is located in the first mobile terminal 110, it can be understood by those skilled in the art that, according to different embodiments, the SIM card 112 can be coupled to the first The mobile terminal 110, or be bound to the first mobile terminal 110 as a virtual SIM card, and the present invention is not limited thereto. The second mobile terminal 120 comprises a memory 122, a control circuit 124, a security circuit 126, and a transceiver 128. Although the memory 122 is located in the second mobile terminal 120 in the present embodiment, it can be understood by those skilled in the art that the memory 122 can be externally coupled to the second mobile terminal 120 according to different embodiments. The invention is not limited thereto. Please note that the first mobile terminal 110 and the second mobile terminal 120 can also comprise other circuits, and the present invention is not limited thereto.

When the second mobile terminal 120 wants to share the SIM card 112 of the first mobile terminal 110, the control circuit 124 of the second mobile terminal 120 can transmit the SIM card access request signal R to the first mobile terminal 110 via the transceiver 128. After the control circuit 114 of the first mobile terminal 110 receives the SIM card access request signal R via the transceiver 118, the first mobile terminal 110 transmits the security authentication information request signal AR to the second mobile terminal 120 via the transceiver 118 according to the SIM card access request signal R. In the embodiment shown in FIG. 5, the security authentication information request signal AR can be generated by the information provided by the security circuit 116. In another embodiment, the security authentication information request signal AR can be generated by information provided by a memory or other circuits (not shown). The present invention is not limited thereto. After the control circuit 124 of the second mobile terminal 120 receives the security authentication information request signal AR via the transceiver 128, the control circuit 124 can transmit the security authentication information A to the first mobile terminal 110 via the transceiver 128. Of course, specifically, according to various embodiments, the security authentication information A can be provided according to the security authentication information request signal AR by the security circuit 126, or by the memory 122 or other circuits (not shown). The present invention is not limited thereto.

After the control circuit 114 of the first mobile terminal 110 receives the security authentication information A via the transceiver 118, the control circuit 114 can determine whether to transmit the SIM card EF data EF to the second mobile terminal 120 according to the security authentication information A. As shown in FIG. 5, the control circuit 114 can make the decision via the security circuit 116, i.e., the security authentication information A is verified by the security circuit 116. After the security authentication is passed, the control circuit 114 sends the SIM card EF data EF to the second mobile terminal 120 via the transceiver 118. In some embodiments, the SIM card EF data EF can be processed (e.g., encrypted) via the security circuit 116. After the control circuit 124 of the second mobile terminal 120 receives the SIM card EF data EF via the transceiver 128 and the security circuit 126 processes (e.g., decrypts), the processed SIM card EF data EF is stored in the memory 122. Of course, according to different embodiments, the control circuit 124 can directly store the SIM card EF data EF into the memory 122.

In an embodiment of the present invention, the control circuit 124 of the second mobile terminal 120 can further transmit the operator authentication authorization information request signal OAR to the first mobile terminal 110 via the transceiver 128. After the control circuit 114 of the first mobile terminal 110 receives the operator authentication authorization information request signal OAR via the transceiver 118, the control circuit 114 can transmit the operator authentication authorization information OA to the second mobile terminal 120 via the transceiver 118. Specifically, in an embodiment, the security circuit 116 can provide the operator authentication authority information OA to the control circuit 114 according to the operator authentication authorization request signal OAR, and the control circuit 114 transmits the operator authentication authorization information OA to the second mobile terminal 120 via the transceiver 118, and the control circuit 124 of the second mobile terminal 120 receives the operator authentication authority information OA via the transceiver 128. In this way, the second mobile terminal 120 can use the communication function of the SIM card 112 using the SIM card EF data EF and the operator authentication authorization information OA. Of course, in one embodiment, the operator authentication authority information OA also can be transmitted to the security circuit 126 for processing, wherein the control circuit 114 and the control circuit 124 can be realized by a processor. The processor can be a central processing unit (CPU) or a general purpose processor, but the present invention is not limited thereto. The security circuit 116 and the security circuit 126 can be realized by the processor alone, or by a hardware circuit alone, or by a combination of the processor and the hardware circuit.

According to an embodiment of the present invention, the control circuit 114 of the first mobile terminal 110 also can determine the security level of the second mobile terminal 120 according to the security authentication information A and transmit the communication information corresponding to the security level to the second mobile terminal via the transceiver 118 according to the security level. The control circuit 114 also can determine the security level of the second mobile terminal 120 by the security circuit 116. When the second mobile terminal 120 transmits the telephone signal outward, the control circuit 114 can determine whether to allow the second mobile terminal 120 to use the SIM card to transmit the telephone signal according to the security level. According to an embodiment of the present invention, when the SIM card 112 receives a telephone signal, the second mobile terminal 120 use the SIM card to receive the telephone signal. After receiving the telephone signal, the control circuit 124 of the second mobile terminal 120 can further decide whether to synchronize the incoming call information corresponding to the telephone signal to the first mobile terminal 110. In another embodiment, the control circuit 124 of the second mobile terminal 120 can decide whether to store the communication record corresponding to the telephone signal according to the communication information from the first mobile terminal 110 or whether to send back the communication record corresponding to the telephone signal to the first mobile terminal 110.

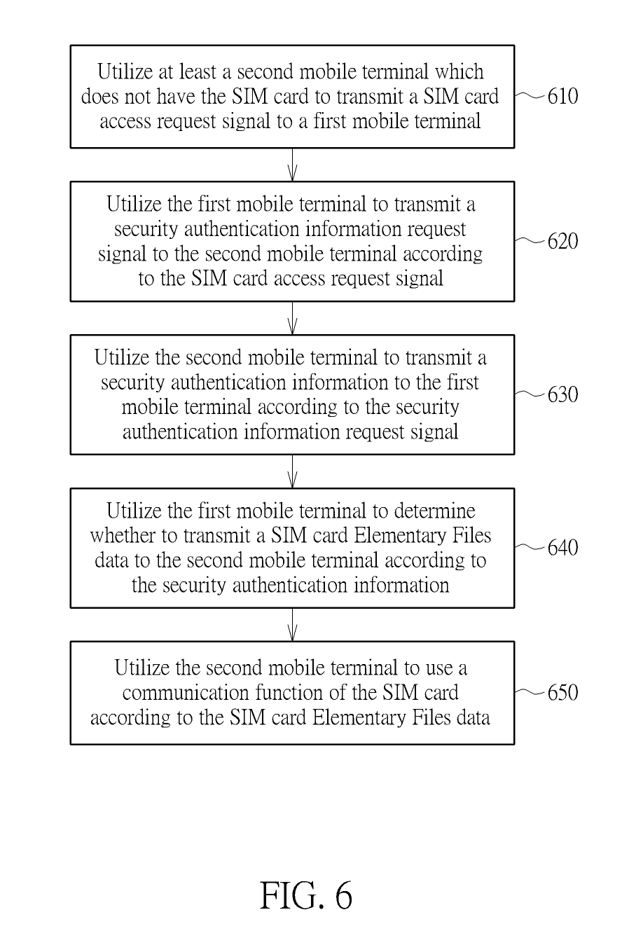

Please refer to FIG. 6. FIG. 6 is a flowchart showing a method for sharing a SIM card in accordance with an embodiment of the present invention. Provided that substantially the same result is achieved, the steps of the process flowchart do not have to be in the exact order shown in FIG. 6 and need not be contiguous, meaning that other steps can be intermediate or certain steps can be ignored. The method comprises the following steps:

Step 610: Utilize at least a second mobile terminal which does not have the SIM card to transmit a SIM card access request signal to a first mobile terminal. The first mobile terminal has the SIM card and operates as a server having no fixed IP.

Step 620: Utilize the first mobile terminal to transmit a security authentication information request signal to the second mobile terminal according to the SIM card access request signal.

Step 630: Utilize the second mobile terminal to transmit a security authentication information to the first mobile terminal according to the security authentication information request signal.

Step 640: Utilize the first mobile terminal to determine whether to transmit a SIM card Elementary Files (EF) data to the second mobile terminal according to the security authentication information.

Step 650: Utilize the second mobile terminal to use a communication function of the SIM card according to the SIM card EF data.

The Step 610 can further comprise: utilizing the second mobile terminal to transmit the SIM card access request signal to the first mobile terminal via a server having a fixed IP address. In addition, the Step 610 also can further comprise: utilizing the second mobile terminal to transmit the SIM card access request signal to the first mobile terminal via an SMS. The Step 620 can further comprise: utilizing the first mobile terminal to transmit the security authentication information request signal to the second mobile terminal according to the SIM card access request signal via the server having the fixed IP address. The Step 630 can further comprise: utilizing the second mobile terminal to transmit the security authentication information to the first mobile terminal according to the security authentication information request signal. The Step 640 can further comprise: utilizing the first mobile terminal to transmit the SIM card EF data to the second mobile terminal according to the security authentication information via the server having the fixed IP address. The Step 650 can further comprise: utilizing the second mobile terminal to use the communication function of the SIM card according to the SIM card EF data via the server having the fixed IP address.

In an embodiment, the Step 650 can further comprise: utilizing the second mobile terminal to transmit the operator authentication authorization request signal OAR to the first mobile terminal according to the SIM card EF data EF to request the operator authentication authorization information OA; utilizing the first mobile terminal to transmit the operator authentication authorization information OA to the second mobile terminal according to the authentication authorization information request signal OAR; and utilizing the second mobile terminal to use the communication function of the SIM card according to the SIM card EF data and the operator authentication authorization information OA.

In addition, the Step 650 can further comprise: when the SIM card in the first mobile terminal receives a telephone signal, utilizing the second mobile terminal to use the SIM card to receive the telephone signal. The step of utilizing the second mobile terminal to use the communication function of the SIM card according to the SIM card basic profile data can further comprise: determining whether to synchronize the incoming call information corresponding to the telephone signal to the first mobile terminal as the server according to the communication information (e.g., permission control information) from the first mobile terminal. Alternatively, the step of utilizing the second mobile terminal to use the communication function of the SIM card according to the SIM card basic profile data can further comprise: determining whether to store a communication record corresponding to the telephone signal in the second mobile terminal according to the communication information (e.g., permission control information) from the first mobile terminal. Alternatively, the step of utilizing the second mobile terminal to use the communication function of the SIM card according to the SIM card basic profile data can further comprise: determining whether to send back the communication record corresponding to the telephone signal to the first mobile terminal as the server according to the communication information (e.g., permission control information) from the first mobile terminal.

In another embodiment, the method of the present invention can further comprise: utilizing the first mobile terminal to determine a security level of the second mobile terminal according to the security authentication information; and utilizing the first mobile terminal to transmit the communication information corresponding to the security level to the second mobile terminal according to the security level. In the present embodiment, the Step 650 can further comprise: determining whether to allow the second mobile terminal to use the SIM to transmit a telephone signal according to the security level when the second mobile terminal transmits the telephone signal outward, wherein when the second mobile terminal is allowed to use the SIM to transmit the telephone signal, the Step 650 can further comprise: when the second mobile terminal is allowed to use the SIM card to transmit the telephone signal, determining whether to synchronize the calling information corresponding to the telephone signal to the first mobile terminal as the server according to the communication information (e.g., permission control information) from the first mobile terminal. Or, when the second mobile terminal is allowed to use the SIM card to transmit the telephone signal, the Step 650 can further comprise: determining whether to store the communication record corresponding to the telephone signal in the second mobile terminal according to the communication information (e.g., permission control information) from the first mobile terminal. Or, when the second mobile terminal is allowed to use the SIM card to transmit the telephone signal, the Step 650 can further comprise: determining whether to send the communication record corresponding to the telephone signal back to the first mobile terminal as the server according to the communication information (e.g., permission control information) from the first mobile terminal. In addition, all of the above steps in the method of the present invention can be realized by one or a combination of software, hardware, and/or firmware in the first mobile terminal and the second mobile terminal. This is only for an illustrative purpose and is not meant to be a limitation of the present invention.

Briefly summarized, the present invention discloses a method and a system that allows a plurality of mobile terminals to share a SIM card. In some embodiments, the present invention can also perform security and permission control for various different mobile terminals according to the security levels of the various mobile terminals.

Those skilled in the art will readily observe that numerous modifications and alterations of the device and method can be made while retaining the teachings of the invention. Accordingly, the above disclosure should be construed as limited only by the metes and bounds of the appended claims.

What is claimed is:

1. A method for sharing a Subscriber Identity Module (SIM) card, comprising:
utilizing a first mobile terminal to receive a SIM card access request signal from at least a second mobile terminal which does not have the SIM card, wherein the first mobile terminal has the SIM card and operates as a server having no fixed IP;
transmitting a security authentication information request signal to the second mobile terminal according to the SIM card access request signal; and
determining whether to transmit a SIM card Elementary Files data to the second mobile terminal according to the security authentication information, wherein the SIM card Elementary Files data is utilized by the second mobile terminal to use a communication function of the SIM card.

2. The method of claim 1, further comprising:
determining a security level of the second mobile terminal according to the security authentication information; and
transmitting a communication information corresponding to the security level to the second mobile terminal according to the security level.

3. The method of claim 2, further comprising:
when the second mobile terminal transmits a phone signal outward, the first mobile terminal determines whether to allow the second mobile terminal using the SIM card to transmits the phone signal outward according to the security level.

4. The method of claim 2, wherein the communication information comprises a communication record information, a contact list information, a short message information, and/or a permission control information.

5. The method of claim 1, further comprising:
receiving an operator authentication authorization information request signal from the second mobile terminal; and
transmitting an operator authentication authorization information to the second mobile terminal according to the operator authentication authorization information request signal, wherein the operator authentication authorization information is utilized by the second mobile terminal to use a communication function of the SIM card.

6. A method for sharing a Subscriber Identity Module (SIM) card, comprising:
utilizing a second mobile terminal which does not have the SIM card to transmit a SIM card access request signal to a first mobile terminal, wherein the first mobile terminal has the SIM card and operates as a server having no fixed IP;
receiving a security authentication information request signal from the first mobile terminal; and
utilizing the security authentication information request signal to transmit a security authentication information to the first mobile terminal;
receiving a SIM card Elementary Files data from the first mobile terminal; and
using a communication function of the SIM card according to the SIM card Elementary Files data.

7. The method of claim 6, wherein the step of using the communication function of the SIM card according to the SIM card Elementary Files data further comprises:
when the SIM card receives a phone signal, the second mobile terminal uses the SIM card to receive the phone signal.

8. The method of claim 7, wherein the step of using the communication function of the SIM card according to the SIM card Elementary Files data further comprises:
determining whether to synchronize a calling information corresponding to the phone signal to the first mobile terminal.

9. The method of claim 7, wherein the step of using the communication function of the SIM card according to the SIM card Elementary Files data further comprises:
determining whether to store a communication record corresponding to the phone signal according to the communication information from the first mobile terminal, or whether to send the communication record corresponding to the phone signal back to the first mobile terminal.

10. The method of claim 6, further comprising:
transmitting an operator authentication authorization information request signal to the first mobile terminal;
receiving the operator authentication authorization information from the second mobile terminal; and
using the communication function of the SIM card according to the operator authentication authorization information and the SIM card Elementary Files data.

11. A mobile terminal, comprising:
a transceiver, for receiving a SIM card access request signal from at least a second mobile terminal which does not have the SIM card, wherein the mobile terminal has the SIM card and operates as a server having no fixed IP; and
a control circuit, for transmitting a security authentication information request signal to the second mobile terminal according to the SIM card access request signal; and determining whether to transmit a SIM card Elementary Files data to the second mobile terminal according to the security authentication information, wherein the SIM card Elementary Files data is utilized by the second mobile terminal to use a communication function of the SIM card.

12. The mobile terminal of claim 11, wherein the control circuit further determines a security level of the second mobile terminal according to the security authentication information; and transmits a communication information corresponding to the security level to the second mobile terminal according to the security level.

13. The mobile terminal of claim 12, wherein when the second mobile terminal transmits a phone signal outward, the mobile terminal determines whether to allow the second mobile terminal using the SIM card to transmits the phone signal outward according to the security level.

14. The mobile terminal of claim 12, wherein the communication information comprises a communication record information, a contact list information, a short message information, and/or a permission control information.

15. The mobile terminal of claim 11, wherein the transceiver further receives an operator authentication authorization information request signal from the second mobile terminal; and the control circuit further transmits an operator authentication authorization information to the second mobile terminal according to the operator authentication authorization information request signal, wherein the operator authentication authorization information is utilized by the second mobile terminal to use a communication function of the SIM card.

16. The mobile terminal of claim 11, further comprising:
a security circuit, for providing the security authentication information request signal to the control circuit, and/or making the control circuit determine whether to transmit the SIM card Elementary Files data to the second mobile terminal via the transceiver.
